(19) United States
(12) Patent Application Publication
(10) Pub. No.: US 2016/0126539 A1
(43) Pub. Date: May 5, 2016

(54) CARBON-TREATED COMPLEX OXIDES AND METHOD FOR MAKING THE SAME

(71) Applicants: JOHNSON MATTHEY PUBLIC LIMITED COMPANY, London (GB); UNIVERSITE DE MONTREAL, Montreal (CA)

(72) Inventors: Nathalie RAVET, Montreal (CA); Michel Gauthier, La Prairie (CA); Thorsten Lahrs, St-bruno-de-montarville (CA); Guoxian Liang, St-hyacinthe (CA); Christophe Michot, Montreal (CA)

(21) Appl. No.: 14/994,281

(22) Filed: Jan. 13, 2016

Related U.S. Application Data
(62) Division of application No. 12/445,645, filed on Jul. 8, 2009.

(30) Foreign Application Priority Data
Oct. 30, 2006 (CA) 2566906

(51) Int. Cl. H01M 4/136; H01M 10/0525; H01M 4/62; H01M 4/04; H01M 4/1397; H01M 4/58

(52) U.S. Cl. CPC H01M 4/136; H01M 4/1397; H01M 4/5825; H01M 4/625; H01M 4/622; H01M 4/0402; H01M 4/0471; H01M 10/0525; H01M 2004/028

(57) ABSTRACT

The invention relates to a process for the preparation of a carbon-treated complex oxide having a very low water content and to its use as cathode material.

The carbon-treated complex oxide is composed of particles of a compound AMXO₄ having an olivine structure which carry, on at least a portion of their surface, a film of carbon deposited by pyrolysis. A represents Li, alone or partially replaced by at most 10% as atoms of Na or K. M represents Fe(II), alone or partially replaced by at most 50% as atoms of one or more other metals chosen from Mn, Ni and Co, and/or by at most 10% as atoms of one or more aliovalent or isovalent metals other than Mn, Ni or Co, and/or by at most 5% as atoms of Fe(III). X₄ represents PO₄, alone or partially replaced by at most 10 mol % of SO₄ and SiO₄. Said material has a water content <1000 ppm.

The present invention relates to a process for the preparation of carbon-treated complex oxides having a very low water content and to their use as cathode material.

During the last 20 years, lithium-ion batteries have become the main source of energy for mobile electronic devices by virtue of their high energy density and their high cycle life. However, safety problems related to the use of LiCoO₂ for the cathode limit the possibility of developing reliable lithium-ion batteries on a large scale. The replacement of LiCoO₂ by a lithium iron phosphate as cathode material has been proposed (cf. U.S. Pat. No. 5,910,382, U.S. Pat. No. 6,391,493 and U.S. Pat. No. 6,514,640). The safety problems are thus solved by virtue of the P—O covalent bond, which stabilizes the completely charged cathode with respect to the release of oxygen. The phosphate LiFePO₄, which has an olivine structure, exhibits nonoptimum kinetics induced by the low intrinsic electronic conductivity, which results from the fact that the PO₄ polyanions are covalently bonded. However, the use of subnanometric particles (proposed in U.S. Pat. No. 5,910,382), preferably in the form of particles carrying a thin layer of carbon at their surface (as described in U.S. Pat. No. 6,855,273, U.S. Pat. No. 6,962,666, WO02/27823 A 1 and WO02/27824 A1), has made it possible to develop and market a phosphate LiFePO₄ carrying a deposit of battery-grade carbon which has a high capacity and which can provide a high power. Lithium iron phosphate can in addition be modified by a partial replacement of the Fe cations by isovalent or aliovalent metal cations, such as, for example, Mn, Ni, Co, Mg, Mo, Nb, Ti, Al, Ta, Ge, La, Y, Yb, Sm, Ce, Hf, Cr, Zr, Bi, Zn, Ca and W, or by partial replacement of the PO₄ oxyanion by SiO₄, SO₄ or MoO₄ (as described in U.S. Pat. No. 6,514,640).

The lithiated cathode materials prepared in the discharge state are supposed to be stable towards oxygen. Mention may in particular be made of the lithiated oxides of at least one of the following elements: cobalt, nickel or manganese. However, the inventors have noticed that, surprisingly, the quality of LiFePO₄ carrying a deposit of carbon, in particular in the form of a powder with a high specific surface or in the form of a coating of a collector in order to form a cathode, can deteriorate during exposure to air or during handling or storage. This results in a detrimental change in the product or in the formation of impurities, which can subsequently exert a harmful effect on the cyclability or the charge potential in the battery comprising the phosphate. The sequence of reactions which brings about the deterioration in the product or the formation of the impurities can be complex and variable, depending on the synthetic route, the methods of deposition of the layer of carbon by pyrolysis, the structure and the form of operation of the battery. The synthesis can be performed, for example, via the hydrothermal route, in the solid state or in the molten state, each route generating specific impurities. A not uncommon deterioration is a conversion of Fe²⁺ to Fe³⁺ with formation of related products.

The aim of the present invention is to identify some of the specific impurities formed during the deterioration of the material and to provide a process which makes it possible to avoid the formation of the impurities and the deterioration of the complex oxide.

The results of the research carried out by the inventors has shown, on the one hand, that the deterioration of a complex oxide (in particular LiFePO₄) carrying a deposit of carbon is, surprisingly, greater than that of a complex oxide without a deposit of carbon and that it is due essentially to the combination of the presence of oxidizing entities (in particular atmospheric oxygen) and of a relatively high level of humidity in the ambient medium or in the reaction medium. In addition, it has been found that the exposure of the same material to dry air results in no deterioration or in a deterioration which remains at a sufficiently low level not to be harmful.

The inventors have thus developed a process in which the atmosphere around the complex oxide is controlled through the duration of the preparation process, including even a stage of pyrolysis and of formation of conductive carbon but also preferably during storage and use, so as to keep the level of humidity of the carbon-treated complex oxide at a value of less than 1000 ppm throughout all the stages of its preparation, storage and use.

This is why a subject matter of the present invention is a C-AMXO₄ material in which the level of humidity is less than 1000 ppm, that is to say a material which is stable over time with regard to oxidation, a process for its preparation and also an electrode which comprises it and the use of this electrode in a lithium battery.

The material which is a subject matter of the present invention, denoted below by “C-AMXO₄ material”, is composed of particles of a compound corresponding to the formula AMXO₄ which have an olivine structure and which carry, on at least a portion of their surface, a film of carbon deposited by pyrolysis, the formula AMXO₄ being such that:
A represents Li, alone or partially replaced by at most 10% as atoms of Na or K;

M represents Fe(II), alone or partially replaced by at most 50% as atoms of one or more other metals chosen from Mn, Ni and Co and/or by at most 10% as atoms of one or more aliovalent or isovalent metals other than Mn, Ni or Co, and/or by at most 5% as atoms of Fe(III),
XO₄ represents PO₄, alone or partially replaced by at most 10 mol % of at least one group chosen from SO₄ and SiO₄;
   said material having a water content of less than 1000 ppm.

In the material of the invention, the deposit of carbon is a uniform, adherent and nonpowdery deposit. It represents from 0.03 to 15% by weight, preferably from 0.5 to 5% by weight, with respect to the total weight of the material.

The material according to the invention, when used as cathode material, exhibits at least one charge/discharge plateau at approximately 3.4-3.5 V vs Li, characteristic of the Fe²⁺/Fe³⁺ couple.

The process according to the present invention consists in preparing the material C-AMXO₄ by a process comprising a stage of pyrolysis of a compound. which is a source of conductive carbon and it is characterized in that said material C-AMXO₄ is placed, immediately after it has been obtained, in a controlled atmosphere and is then kept in said controlled atmosphere, said controlled atmosphere either being an oxidizing atmosphere with a dew point of less than −30° C., preferably of less than −50° C. and more particularly of less than −70° C., or a nonoxidizing atmosphere.

In the continuation of the text, the expression “controlled atmosphere” will denote a nonoxidizing atmosphere or an oxidizing atmosphere with a dew point of less than −30° C.

In a 1st specific embodiment, the material C-AMXO₄ is composed of particles of a compound corresponding to the formula AMXO₄ which have an olivine structure and which carry, on at least a portion of their surface, a film of carbon deposited by pyrolysis, the formula AMXO₄ being such that:
A represents Li, alone or partially replaced by at most 10% as atoms of Na or K;
M represents Fe(II), alone or partially replaced by at most 50% as atoms of one or more other metals chosen from Mn, Ni and Co and/or by at most 10% as atoms of one or more aliovalent or isovalent metals chosen from Mg, Mo, Nb, Ti, Al, Ta, Ge, La, Y, Yb, Sm, Ce, Hf, Cr, Zr, Bi, Zn, Ca and W and/or by at most 5% as atoms of Fe(III);
XO₄ represents PO₄, alone or partially replaced by at most 10 mol % of at least one group chosen from SO₄ and SiO₄.

It is characterized in that it comprises less than 1000 ppm of water, preferably less than 500 ppm, more particularly less than 200 ppm.

In a 2nd embodiment, the complex oxide AMXO₄ comprises less than 1000 ppm of water and less than 1000 ppm of LiOH, of Li₃PO₄, of Li₄P₂O₇, of lithium polyphosphates, optionally hydrated, or of Li₂CO₃, preferably less than 500 ppm, and more particularly less than 200 ppm.

In a 3rd embodiment, the complex oxide AMXO₄ comprises less than 1000 ppm of water and less than 10 000 ppm of Fe₂O₃, Li₃Fe₂(PO₄)₃, LiFeP₂O₇, or an Fe³⁺ compound which can be detected electrochemically, preferably less than 5000 ppm and more particularly less than 2000 ppm.

The level of humidity of the material according to the invention can be measured using devices commonly used in industry. Mention may be made, as example, of Computrac Vapor Pro L, sold by Arizona Instrument LLC (USA), or the moisture measuring devices of Mettler Toledo (USA) or Brinkmann (USA).

The properties of the materials according to the invention can be adapted by appropriately choosing the element or elements partially replacing Fe. For example, in the material in which the complex oxide corresponds to the formula LiFe_{1-x-y}M′ₓM″_{y}PO₄, the choice of M′ from Mn, Ni and Co makes it possible to adjust the average discharge potential of the cathode material. The choice of M″ from Mg, Mo, Nb, Ti, Al, Ca and W makes it possible to adjust the kinetic properties of the cathode material.

Among the above materials, those in which the complex oxide AMXO₄ corresponds to the formula LiFe₁₋ₓMnₓPO₄, with 0≦x≦0.5, are particularly preferred.

In a particularly advantageous embodiment, the complex oxide AMXO₄ is LeFePO₄ and the material comprises less than 1000 ppm of water and less than 1000 ppm of LiOH, of Li₃PO₄, of Li₄P₂O₇, of lithium polyphosphates, optionally hydrated, or of Li₂CO₃, preferably less than 500 ppm and more particularly less than 200 ppm. In addition, it is preferable for the material to comprise less than 10 000 ppm of Fe₂O₃, of Li₃Fe₂(PO₄)₃, or LiFeP₂O₇, or of an Fe³⁺ compound detectable electrochemically, preferably less than 5000 ppm and more particularly less than 2000 ppm.

In the context of the present invention, the expression “particles” encompasses both individual particles and agglomerates of individual particles. The size of the individual particles is preferably between 10 nm and 3 μm. The size of the agglomerates is preferably between 100 nm and 30 μm. These particle sizes and the presence of the carbon deposit confer, on the material, a high specific surface typically of between 5 and 100 m²/g.

The material C-AMXO₄ can be prepared by various processes, before being placed in a controlled atmosphere as defined above. It can be obtained, for example, via a hydrothermal route, via a solid-state thermal route or via a melt route.

In a preferred embodiment, the process of the invention is carried out by reacting, by placing under thermodynamic or kinetic equilibrium, a gas atmosphere with a mixture in the required proportions of the following source compounds a), is b), c), d) and e):

a) one or more compounds which are sources of the element or elements forming A,
b) a source or several sources of the element or elements forming M;
c) a compound which is a source of the element or elements X;
d) a compound which is a source of oxygen;
e) a compound which is a source of conductive carbon;
the synthesis being carried out continuously in a rotary furnace while controlling the composition of said gas atmosphere, the temperature of the synthesis reaction and the level of the source compound c) relative to the other source compounds a), b), d) and e), in order to fix the oxidation state of the transition metal at the degree of valency desired for the structure of the compound of type AMXO₄,
the process comprising a stage of pyrolysis of the compound e).

In this embodiment, the gas stream and the stream of solid products move countercurrentwise. If the controlled gas atmosphere is dry nitrogen, the material C-AMXO₄ recovered at the outlet of the furnace comprises less than 200 ppm of water. This material C-AMXO₄ thus obtained is immediately transferred into a controlled atmosphere, such as defined above.

The water content of the final material depends, on the one hand, on the water content of the controlled atmosphere and, on the other hand, on the duration of maintenance in said atmosphere. The water content of the material increases when the duration of maintenance in the controlled atmosphere increases and when the water content of the controlled atmosphere increases.

The process of the invention is of particular use in the preparation of a C—LiFePO₄ material comprising less than 1000 ppm of water. For the preparation of this material, the source compound a) is a lithium compound chosen, for example, from the group consisting of lithium oxide, lithium hydroxide, lithium carbonate, the neutral phosphate Li₃PO₄, the hydrogen phosphate LiH₂PO₄, lithium ortho-, meta- or polysilicates, lithium sulfate, lithium oxalate, lithium acetate and one of their mixtures. The source compound b) is a compound of iron, for example iron(III) oxide or magnetite, trivalent iron phosphate, lithium iron hydroxyphosphate or trivalent iron nitrate, ferrous phosphate, hydrated or nonhydrated vivianite Fe₃(PO₄)₂, iron acetate (CH₃COO)₂Fe, iron sulfate (FeSO₄), iron oxalate, ammonium iron phosphate (NH₄FePO₄), or one of their mixtures. The source compound c) is a compound of phosphorus, for example phosphoric acid and its esters, the neutral phosphate Li₃PO₄, the hydrogen phosphate LiH₂PO₄, monoammonium or diammonium phosphates, trivalent iron phosphate or manganese ammonium phosphate (NH₄MnPO₄). All these compounds are additionally a source of oxygen and some of them are sources of at least two elements from Li, Fe and P. The deposition of carbon on the surface of the particles of complex oxide AMXO₄ is obtained by pyrolysis of a source compound e).

The pyrolysis of the compound e) can be carried out at the same time as the synthesis reaction between the compounds a) to d) to form the compound AMXO₄. It can also be carried out in a stage in succession to the synthesis reaction.

The deposition of the layer of conductive carbon at the surface of the particles of complex oxide AMXO₄ can be obtained by thermal decomposition of highly varied source compounds e). An appropriate source compound is a compound which is in the liquid state or in the gas state, a compound which can be used in the form of a solution in liquid solvent, or a compound which changes to the liquid or gas state during its thermal decomposition, so as to more or less completely coat the particles of complex oxide.

The source compound e) can, for example, be chosen from liquid, solid or gaseous hydrocarbons and their derivatives (in particular polycyclic aromatic entities, such as tar or pitch), perylene and its derivatives, polyhydric compounds (for example, sugars and carbohydrates, and their derivatives), polymers, cellulose, starch and their esters and ethers, and their mixtures. Mention may be made, as examples of polymers, of polyolefins, polybutadienes, polyvinyl alcohol, condensation products of phenols (including those obtained from reaction with aldehydes), polymers derived from furfuryl alcohol, from styrene, from divinylbenzene, from naphthalene, from perylene, from acrylonitrile and from vinyl acetate.

When the compound e) is CO or a gaseous hydrocarbon, it is subjected to dismutation, advantageously catalyzed by a transition metal element present in at least one of the precursors a) to c) or by a compound of a transition metal added to the mixture of precursors.

When the source compound e) is a gas or a mixture of gases, such as ethylene, propylene, acetylene, butane, 1,3-butadiene or 1-butene, the thermal decomposition is carried out by cracking in a furnace at a temperature between 100 and 1300° C. and more particularly between 400 and 1200° C., preferably in the presence of an inert carrier gas (cf., for example, US 2002/195591 A1 and US 2004/157126 A1).

The deposition of carbon can, in addition, be carried out by CVD starting from hydrocarbons, as described in JP 2006-302671.

In the various processes for the preparation of the carbon-treated complex oxides C-AMXO₄, some stages can bring about sintering or agglomeration of the particles. It is therefore strongly recommended to subject the complex oxide obtained by the synthesis to a milling in order to ensure the homogeneity of the final product and to control the size and optionally the degree of deagglomeration thereof. Jet milling is a convenient means for controlling the sizes of the particles and agglomerates. However, it has been found that, in some cases, it causes irreversible damage to the product. The process of the present invention is thus of particular use when the preparation of the complex oxide intended to form the active material of a cathode has to be subjected to milling in order to have the optimum particle size. The milling is carried out in a controlled atmosphere, such as defined above, and on a material comprising less than 1000 ppm of water, such as obtained at the end of the pyrolysis stage.

In a specific embodiment, the process for the preparation of the material according to the invention comprises a stage of washing the material C-AMXO₄ in hot water, for example at a temperature of greater than 60° C. It has been found that the material obtained subsequently, by extraction from the aqueous medium (for example by filtration or by centrifuging) and drying, exhibits high stability when it is used as cathode active material in a lithium ion battery. The specific capacity is equivalent to, indeed even higher than, that which is obtained with an identical material which comprises less than 1000 ppm of water and which has not been subjected to washing.

The irreversible damage to C—LiFePO₄ when it is exposed to moist air, that is to say both to oxygen and to water, can be the result of various chemical processes. The following mechanisms are given below but without implied limitation.

LiFePO₄+¼O₂+½H₂O→FePO₄+LiOH (LiOH changing to LiCO₂),

3LiFePO₄+¾O₂+½H₂O→LiFeP₂O₇+Fe₂O₃+LiH₂PO₄

3LiFePO₄+¾O₂→Li₃Fe₂(PO₄)₃+½Fe₂O₃

The mechanisms of deterioration might also involve impurities originating from the synthesis of LiFePO₄ or impurities produced or modified during the pyrolysis stage carried out in order to deposit the conductive carbon in the core of the particles or at their surface.

The inventors have discovered that the materials C—LiFePO₄ carrying a carbon coating are more sensitive to deterioration by moist air than carbon-free materials LiFePO₄, in particular when they have a high specific surface. For a material C—LiFePO₄, several electrochemical mechanisms of deterioration can be envisaged, because of the threefold contact between the gas phase, the conductive carbon and the compounds which comprise the Fe²⁺ entity (the complex oxide LiFePO₄ and/or various impurities which depend on the route of synthesis of LiFePO₄, for example Fe₂P or Fe₂P₂O₇). These mechanisms can be represented by

2Fe²⁺→2Fe³⁺+2e⁻+2Li⁺

½O₂+H₂O+2e⁻+2Li³⁰ →2LiOH

The formation of Fe³⁺ and the formation of LiOH are concomitant. The exact nature of the decomposition products is uncertain, owing to the fact that these products can react with one another or with other elements of an electrochemical cell comprising the material C—LiFePO₄. However, their presence and their electrochemical activity are illustrated in the examples described subsequently in the present text.

In other words, when the material C—LiFePO₄ is brought into contact with oxygen and water, it can be regarded as a short-circuited carbon-LiFePO₄ battery, the water acting as electrolyte, owing to the fact that the surface of the LiFePO₄ particles is not completely covered with the carbon, and O₂ acting as oxidizing agent. The combination of several electrochemical couples, of a high specific surface and of the activation of the surface by the carbon might explain the specific difficulties encountered during the storage and use of C—LiFePO₄ in the presence of moist air.

The possible release of LiOH/Li₂CO₃ can cause not only an irreversible loss in capacity but also the deterioration of an electrolyte comprising LiPF₆ or other elements of a battery.

Even if these specific difficulties exhibit disadvantages, in particular for laboratory experiments, they can be solved on the industrial scale by appropriate technological solutions, in particular by controlling the conditions of exposure of the material to O₂ and moisture.

A material C-AMXO₄ according to the invention is of particular use as cathode in a lithium battery. The lithium battery can be a solid electrolyte battery in is which the electrolyte can be a plasticized or nonplasticized polymer electrolyte, a battery in which a liquid electrolyte is supported by a porous separator or a battery in such the electrolyte is a gel.

The cathode is preferably composed of a composite material applied to a collector, said composite material comprising C-AMXO₄, a binder and a material which promotes electronic conduction. The material which promotes electronic conduction is advantageously chosen from carbon black, graphite or carbon fibers (for example in the form of carbon nanotubes or of VGCF (vapor grown carbon fiber) fibers, the growth of which is carried out in the gas phase).

The capacity of the cathode is commonly expressed in mg of electroactive material per cm² of the surface of the cathode.

When the cathode is intended for a polymer electrolyte battery, the binder is preferably a solvating polymer, preferably the polymer which forms the solvent of the electrolyte.

When the cathode is intended for a liquid electrolyte battery, the binder can be a nonsolvating polymer, for example a PVdF-HFP copolymer or a styrene-butadiene-styrene copolymer.

The cathode is prepared from a material C-AMXO₄ having a water content of less than 1000 ppm, used directly after its synthesis or stored in a controlled atmosphere and/or treated in a controlled atmosphere. If it is necessary to mill the particles of C-AMXO₄ before incorporating them in the cathode composite material, it is advisable to carry out the milling under a controlled atmosphere. A milling technique which is particularly useful is jet milling.

A material C—LiFePO₄ and a material C—LiMPO₄ in which M represents Fe partially replaced by Mn or Mg are particularly preferred as cathode active material.

The process according to the invention was employed by way of comparison with the techniques of the prior art in order to demonstrate that restricting the moisture level to very low values has a favorable effect on the performance of the material C-AMXO₄ used as cathode material in a lithium battery.

In all the tests, the water contents of the materials were determined using a Computrac Vapor Pro L sold by Arizona Instruments LLC.

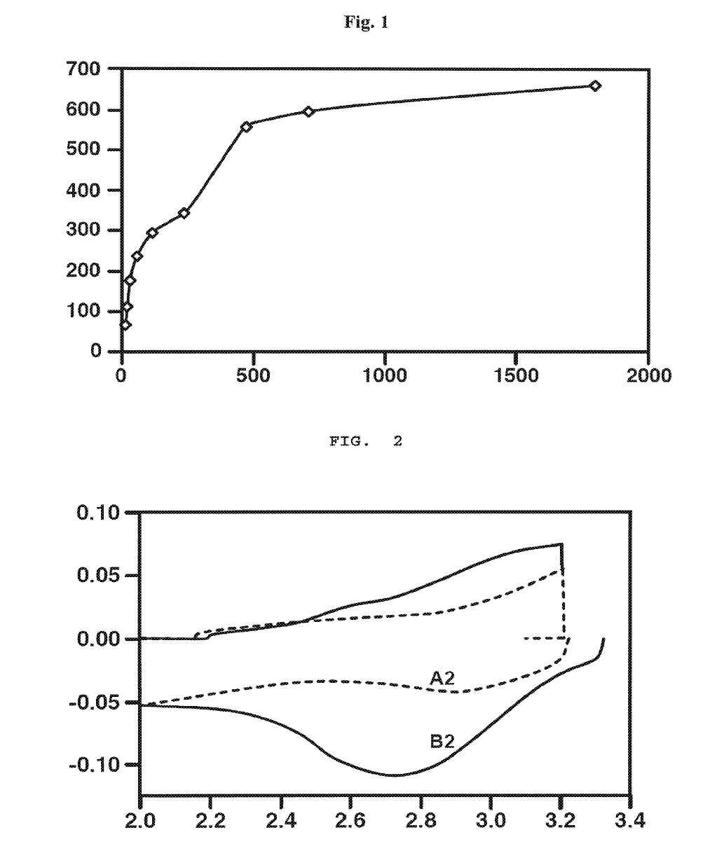

The results are reproduced in FIGS. 1 to 8.

FIG. 1 represents the water content of a material C—LiFePO₄ having a carbon content of approximately 1.8% and a specific surface of 13 m²/g for different times of exposure to an air atmosphere with a relative humidity of 20%. The water content, expressed in ppm, is given on the ordinate and the exposure time, expressed in seconds, is given on the abscissa.

FIG. 2 represents an ambient temperature slow voltammetry diagram for two batteries A2 and B2 of the Li/1M LiPF₆ EC:DEC 3:7/C—LiFePO₄ type. The standardized current (in mAh/g) is shown on the ordinate and the potential vs Li⁺/Li (in volts) is shown on the abscissa. The 1st scanning is carried out in reduction (upper curves A2 and B2) and the 2nd scanning is carried out in oxidation (lower curves A2 and B2). The positive electrode of the battery B2 was prepared from a material C—LeFiPO₄ which remained in the air for 8 days after it was obtained. The positive electrode of the battery A2 was prepared from a material C—LiFePO₄ directly after it was obtained.

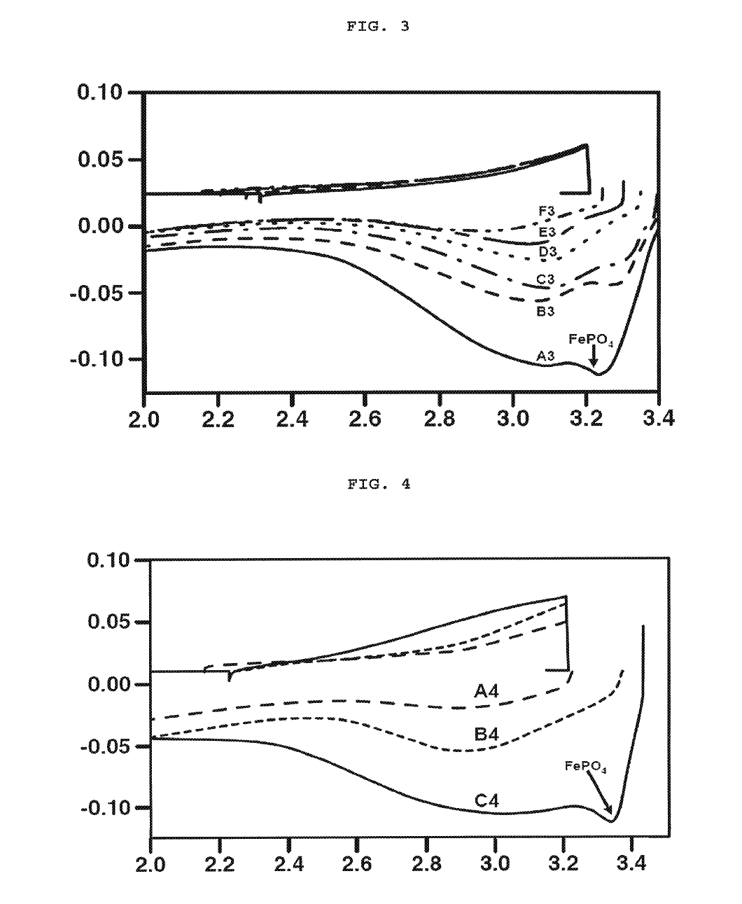

FIG. 3 represents an ambient temperature slow voltammetry diagram for batteries A3, B3, C3, D3, E3 and F3 of the Li/1M LiPF₆ EC:DEC 3:7/C—Li₁₋ₓFePO₄ type. The standardized current (in mAh/g) is shown. on the ordinate and the potential vs Li⁺/Li (in volts) is shown on the abscissa. The 1st scanning is carried out in reduction (upper curves A3 to F3) and the 2nd scanning is carried out in oxidation (lower curves A3 to F3). The materials C—Li₁₋ₓFePO₄ of the positive electrode of the batteries A3 to E3 were prepared by chemical oxidation of C—LiFePO₄ by phenyliodoso diacetate in acetonitrile. The correspondence between the batteries and the various values of the degree x is as follows:

| | A3 | B3 | C3 | D3 | E3 | F3 |
|---|---|---|---|---|---|---|
| x | 0.1 | 0.08 | 0.06 | 0.04 | 0.02 | 0 |

The material C—Li₁₋ₓFePO₄ of the positive electrode of the battery F3 used as control (x=0) was treated in the same way as the others in pure acetonitrile before being deposited on the collector.

FIG. 4 represents an ambient temperature 60° C. slow voltammetry diagram for three batteries A4, B4 and C4 of the Li/1M LiPF₆ EC:DEC 3:7/C—LiFePO₄ type. The standardized current (in mAh/g) is shown on the ordinate and the potential vs Li⁺/Li (in volts) is shown on the abscissa. The 1st scanning is carried out in reduction (upper curves A4, B4 and C4) and the 2nd scanning is carried out in oxidation (lower curves A4, B4 and C4). For each battery, the positive electrode was prepared from a powder formed of material C—LiFePO₄ directly after it was obtained. A freshly prepared electrode was mounted in the battery A4. For the batteries B4 and C4, the electrode was mounted respectively after storing under ambient air for 8 days and 31 days.

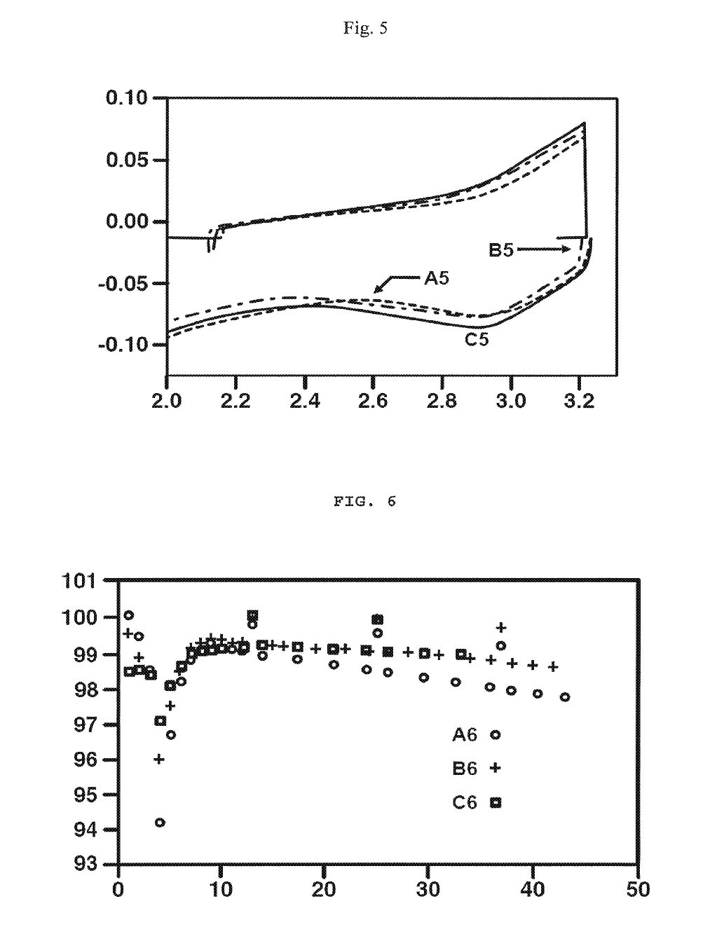

FIG. 5 represents an ambient temperature slow voltammetry diagram for three batteries A5, B5 and C5 of the Li/1M LiPF₆ EC:DEC 3:7/C—LiFePO₄ type. The standardized current (in mAh/g) is shown on the ordinate and the potential vs Li⁺/Li (in volts) is shown on the abscissa. The 1st scanning is carried out in reduction (upper curves A5, B5 and C5) and the 2nd scanning is carried out in oxidation (lower curves A5, B5 and C5). For each battery, the positive electrode was prepared from a powder formed of material C—LiFePO₄ directly after it was obtained. A freshly prepared electrode was mounted in the battery A5. For the batteries B5 and C5, the electrode was mounted after storing for 31 days respectively under dry argon (battery B5) and under dry air (battery C5).

FIG. 6 represents the C/4 galvanostatic cycling curve at 60° C. for three batteries A6, B6 and C6 of the Li/1M LiPF₆ EC:DEC 3:7/C—LiFePO₄ type. The capacity, standardized in % relative to that obtained during the 1st discharge cycle in slow voltammetry, is shown on the ordinate and the number of cycles is shown on the abscissa. For each battery, the positive electrode was prepared from a powder formed of material C—LiFePO₄ directly after it was obtained. The electrode thus prepared was used after storing for 31 days under ambient air for the battery A6, under dry argon for the battery B6 and under dry air for the battery C6.

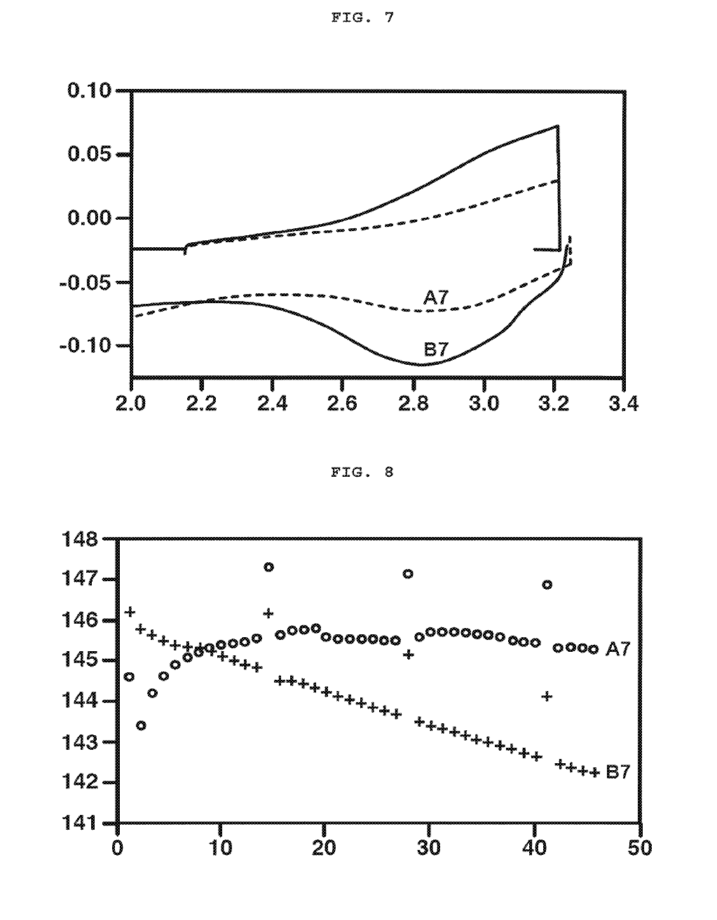

FIG. 7 represents an ambient temperature slow voltammetry diagram for batteries A7 and B7 of the Li/1M LiPF₆ EC:DEC 3:7/C—LiFePO₄ type. The standardized current (in mAh/g) is shown on the ordinate and the potential vs Li⁺/Li (in volts) is shown on the abscissa. The 1st scanning is carried out in reduction (upper curves A7 and B7) and the 2nd scanning is carried out in oxidation (lower curves A7 and B7). The positive electrodes were prepared by depositing, on a collector, the material C—LiFePO₄ immediately after it was obtained, without milling for the electrode of the battery A7 and with jet milling under compressed air for 3 min with a dew point of −6° C. for the electrode of the battery B7.

FIG. 8 represents the C/4 galvanostatic cycling curve at 60° C. for the batteries A7 and B7 produced after the cyclic voltammetry. The capacity of the battery (in mAh per g of C—LiFePO₄) is shown on the ordinate and the number of cycles is shown on the abscissa.

### EXAMPLE 1a

### Synthesis of C—LiFePO₄

A mixture comprising FePO₄.(H₂O)₂ (1 mol, sold by Budenheim, grade E53-81) and Li₂CO₃ (1 mol, sold by Limtech, level of purity: 99.9%) in stoichiometric amounts and 5% of polyethylene-block-poly(ethylene glycol) comprising 50% of ethylene oxide (sold by Aldrich) was prepared and was introduced into isopropyl alcohol, mixing was carried out for approximately 10 h and then the solvent was removed. In the material thus obtained, the polymer keeps together the particles of phosphate and of carbonate.

The mixture was treated under a stream of nitrogen at 700° C. for 2 hours, in order to obtain a material C—LiFePO₄ of battery grade, drying was then carried out under vacuum at 100° C. and the final material was stored in a glovebox under an argon atmosphere at a dew point of −90° C.

The material has a specific surface of 13.6 m²/g and a carbon content of 1.8% by weight

### Sensitivity to Water of the Milled Material C—LiFePO₄

The material obtained was subjected to jet milling under compressed air for 3 min at a dew point of −70° C. and then the material thus obtained was divided into several fractions.

Each fraction was dried under vacuum at 120° C. for 1 hour (in order to obtain a perfectly dry sample) and then exposed to an atmosphere having a relative water content of 20%. The exposure time is different for each fraction, which made it possible to ascertain the change in the water content as a function of the exposure time. For the measurement, each sample is placed in an airtight septum flask. FIG. 1 represents the change in the water content of the material as a function of the duration of the contact with the moist atmosphere.

It is apparent that, surprisingly, the material C—LiFePO₄ adsorbs not insignificant amounts of water, despite the deposition of a surface layer of carbon, which is hydrophobic. The water content is thus approximately 200 ppm after 30 sec, approximately 500 ppm after approximately 10 min and greater than 2000 ppm after 3 hours.

These results show that C—LiFePO₄ presents a specific and surprising problem of water reuptake and that the drying and handling conditions have to be under perfect control in order to produce a product of battery quality.

### EXAMPLE 1b

### Synthesis of C—LiFe_{0.5}Mn_{0.5}PO₄

A compound LiFe_{0.5}Mn_{0.5}PO₄ was prepared by mixing the precursors LiH₂PO₄, FeC₂O₄.2H₂O and (CH₃COO)₂Mn.4H₂O in stoichiometric amounts. The mixture was subsequently milled in heptane, then dried and gradually heated up to 40° C. under air in order to decompose the acetate and oxalate groups. This temperature was maintained for 8 hours. During this treatment, the iron(II) is oxidized to iron(III).

The mixture was subsequently remilled in an acetone solution comprising an amount of cellulose acetate (carbon precursor) representing 39.7% by weight of acetyl groups and 5% by weight with respect to the mixture.

After drying, the mixture was heated in a tubular furnace up to 700° C. at the rate of 6° C. per minute. This temperature was maintained for one hour and then the sample was cooled over 40 minutes, i.e. with a cooling rate of approximately 15° C. per minute. The tubular furnace was maintained under flushing with the reducing gas (CO/CO₂: 1/1) throughout the duration of the heat treatment (approximately 3 and a half hours).

A material C—LiFe_{0.5}Mn_{0.5}PO₄ of battery grade was thus obtained, which was dried under vacuum at 100° C. and then stored in a glovebox under an argon atmosphere at a dew point of −90° C.

This material has a specific surface of 16.2 m²/g and a carbon content of 1.2% by weight.

Under the same conditions as in example 1a, the milled material exhibits a level of moisture of greater than 500 ppm after 15 min of exposure to an atmosphere having a relative water content of 20%.

### EXAMPLE 1c

### Synthesis of C—LiFe_{0.98}Mg_{0.02}PO₄

A compound LiFe_{0.98}Mg_{0.02}PO₄ was prepared by a melt process. The compounds Fe₂O₃, Li₂CO₃, (NH₄)₂HPO₄ and MgHPO₄ were mixed in a molar ratio of 0.49/0.5/0.98/0.02 and then this mixture was brought under argon to 980° C. in a graphite crucible, was maintained at this temperature for 1 hour, in order to melt it, and was then cooled to approximately 50° C. in 3 hours.

The compound LiFe_{0.98}Mg_{0.02}PO₄ thus obtained was subsequently milled in 90 cm³ of isopropanol for 10 min with 12 g of zirconia. beads having a diameter of 20 mm and then for 90 min with 440 g of zirconia beads having a diameter of 3 mm, in order to obtain a powder with a mean size of 1.12 μm.

The LiFe_{0.98}Mg_{0.02}PO₄ powder obtained after milling was mixed with 7% by weight of cellulose acetate and then dried and treated at 700° C. for 1 hour under argon to give a material C—LiFe_{0.98}Mg_{0.02}PO₄ comprising a deposit of 1.32% by weight of carbon and exhibiting a specific surface of 19.2 m²/g.

Under the same conditions as in example 1a, the milled material exhibits a level of moisture of greater than 500 ppm after 15 min of exposure to an atmosphere having a relative water content of 20%.

### EXAMPLE 1d

### Synthesis of C—LiFePO₄ by a Hydrothermal Process

A compound LiFePO₄ was prepared by a hydrothermal process, such as described in example 4 of US 2007/054187, from FeSO₄, H₃PO₄ and LiOH as precursors. The LiFePO₄ powder thus obtained was mixed with lactose monohydrate, such as described in example 5 of US 2007/054187, and then subjected to a heat treatment in order to pyrolyze the lactose monohydrate, according to the procedure described in example 5 of US 2007/054187. After deagglomeration, a material C—LiFePO₄ was thus obtained in the form of particles having a mean size of less than 0.6 μm and having a specific surface of 17.4 m²/g.

Under the same conditions as in example 1a, the milled material exhibits a level of moisture of greater than 800 ppm after 15 min of exposure to an atmosphere having a relative water content of 20%.

### EXAMPLE 2

### Preparation of C—Li₁₋ₓFePO₄

Four samples of the material from example 1 were prepared and were treated for 3 hours with different amounts of phenyliodoso diacetate in dry acetonitrile. The relative amounts of phosphate and diacetate were chosen in order to obtain the materials C—Li₁₋ₓFePO₄ in which x is respectively approximately 0.02, 0.04, 0,06, 0.08 and 0.1. After filtering and washing with dry acetonitrile, the product was dried under vacuum at 80° C. for 3 hours.

### EXAMPLE 3

### Preparation of Liquid Electrolyte Batteries

Liquid electrolyte batteries were prepared according to the following procedure.

A PVdF-HFP copolymer (supplied by Atochem) and an EBN-1010 graphite powder (supplied by Superior Graphite) were carefully mixed in N-methyl-pyrrolidone for one hour using zirconia beads in a Turbula® mixer in order to obtain a dispersion composed of the PVH-HFP/graphite/NMP 80/10/10 by weight mixture. The mixture obtained was subsequently deposited, using a Gardner® device, on a sheet of aluminum carrying a carbon-treated coating (supplied by Intellicoat) and the film deposited was dried under vacuum at 80° C. for 24 hours and then stored in a glovebox.

A battery of the “button” type was assembled and sealed in a glovebox, use being made of the carbon-treated sheet of aluminum carrying the coating comprising the material C—LiFePO₄, as cathode, a film of lithium, as anode, and a separator having a thickness of 25 μm (supplied by Celgard) impregnated with a 1M solution of LiPF₆ in an EC/DEC 3/7 mixture.

In the various batteries assembled according to this procedure, the cathode material comprises either the material C—LiFePO₄ directly obtained by the process of example 1 (x=0, fresh), or a material C—LiFePO₄ of example 1 after storage, or a material C—Li₁₋ₓFePO₄ of example 2. The natures of the modified materials are summarized in the following table. The term “fresh” means that the material is used immediately after it has been synthesized according to example 1. The term “new” means that the cathode is mounted in the battery as soon as it is prepared. The capacity C of the cathode of the battery is also shown in the table, said capacity being expressed in mg of electroactive material C—Li₁₋ₓFePO₄ per cm² of the surface of the cathode.

| Battery | C—Li₁₋ₓFePO₄ | Cathode | C (mg/cm²) |
|---|---|---|---|
| A2 | x = 0, fresh | New | 5.51 |
| B2 | x = 0, storing under air for 8 days | New | 4.43 |
| A3 | x = 0.1 | New | 4.96 |
| B3 | x = 0.08 | New | 3.51 |
| C3 | x = 0.06 | New | 5.12 |
| D3 | x = 0.04 | New | 4.66 |
| E3 | x = 0.02 | New | 5.01 |
| F3 | x = 0, fresh | New | 5.12 |

### Analysis by Cyclic Voltammetry

Before cycling, the new batteries are subjected to a potential scanning in reduction (20 mV/80 s) from the rest potential up to 2 V. This technique makes it possible to detect the electrochemical activity of Fe(III) impurities present in the starting material C—LiFePO₄. This scanning in reduction is followed by a scanning in oxidation up to 3.2 V, which makes it possible to study the reversibility of the couple.

The batteries A2 and B2 were subjected to scanning cyclic voltammetry at ambient temperature with a rate of 20 mV/80 s using a VMP2 multichannel potentiostat (Biologic Science Instruments), first in reduction from the rest potential up to 2 V and then in oxidation between 2 and 3.2 V. The corresponding voltammograms are represented in FIG. 2. For the battery B2, the reduction and oxidation peaks are more intense, which indicates that the level of impurities comprising Fe(III) is greater than in A2. It is important to note that the reoxidation of this impurity takes place partly before 3.2 V. The behavior of the battery B2 is assumed to be due to the formation of Fe(III) impurities during the storage of the phosphate in air.

The batteries A3 to F3, which have been chemically delithiated, were subjected to cyclic voltammetry under the same conditions as the batteries A2 and B3. The corresponding voltammograms are represented in FIG. 3. The reoxidation peaks are identical for all the batteries. This demonstrates that the reoxidation peaks observed before 3.2 V do not correspond to the activity of C—LiFePO₄. Moreover, the partial chemical oxidation undergone by the materials did not result in an increase in the activity of the peak of impurities. This indicates that the impurity is not present in the reduced form in the starting material but indeed originates from deterioration of C—LiFePO₄.

### EXAMPLE 4

### Preparation of Solid Electrolyte Batteries

In the various batteries assembled in this example, the cathode is prepared with the cathode material comprising C—LiFePO₄ directly obtained by the process of example 1. Subsequently, the cathode is mounted directly in the battery after it has been prepared (new) or it is stored under certain conditions before mounting in the battery. In the following table, “Fe(III)” indicates the content of Fe(III) formed with respect to the amount of Fe(II), “ΔFe(III)” indicates the increase in the level of Fe(III) during storage and C denotes the capacity of the cathode of the battery, expressed in mg of electroactive material per cm² of the surface of the cathode.

| Battery | Cathode | Fe(III) | ΔFe(III) | C (mg/cm²) |
|---|---|---|---|---|
| A4 | New | 0.9 | — | 5.51 |
| B4 | Storage in the ambient | 2.4 | 166% | 4.76 |
| | air for 8 days | | | |
| C4 | Storage in the ambient | 4.6 | 411% | 4.49 |
| | air for 31 days | | | |
| A5 | New | | | 5.51 |
| B5 | Storage under dry | | | 4.80 |
| | argon for 31 days | | | |
| C5 | Storage under dry | | | 3.81 |
| | air for 31 days | | | |
| A6 | Storage in the ambient | | | 5.11 |
| | air for 31 days | | | |
| B6 | Storage under dry | | | 5.8 |
| | argon for 31 days | | | |
| C6 | Storage under dry air | | | 3.81 |
| | for 31 days | | | |
| A7 | C—LiFePO₄ used from | | | 3.01 |
| | its preparation | | | |
| B7 | C—LiFePO₄ after milling | | | 4.73 |

The solid electrolyte batteries were prepared according to the following procedure.

2.06 g of C—LiFePO₄, 1.654 g of poly(ethylene oxide) having a molecular weight of 400 000 (supplied by Aldrich) and 334 mg of Ketjenblack carbon powder (supplied by Akzo-Nobel) were carefully mixed for 1 hour in acetonitrile using zirconia beads in a Turbula® mixer, The mixture obtained was subsequently deposited, using a Gardner® device, on a sheet of aluminum carrying a carbon-treated coating (supplied by Intellicoat) and the film deposited was dried under vacuum at 80° C. for 12 hours and then stored in a glovebox.

A battery of the “button” typed was assembled and sealed in a glovebox, use being made of the carbon-treated sheet of aluminum carrying the coating comprising the phosphate, as cathode, a film of lithium, as anode, and a film of poly(ethylene oxide) comprising 30% by weight of LiTFSI (supplied by 3M).

### Analysis by Cyclic Voltammetry

The batteries A4 to C4 and A5 to C5, assembled according to this procedure, were subjected to voltammetry as described in example 3. The corresponding voltammograms are represented in FIG. 4 for the batteries A4 to C4 and in FIG. 5 for the batteries A5 to C5.

As above, the behavior of the batteries B4 and C4 can be attributed to the production of Fe(III) impurities during the storage in air of the cathodes prepared from “fresh” LiFePO₄, said impurities being FePO₄ for the battery C4.

As regards the batteries B5 and C5, it is apparent that impurities are not formed during storage under dry argon or under dry air, the appearance of the curve in oxidation not being modified.

### Galvanostatic Cycling

The batteries A6, B6 and C6, assembled like the batteries A4 to C4 and A5 to C5, were subjected to CM galvanostatic cycling at 60° C. The curves are represented in FIG. 6. The results confirm that, in addition to the production of Fe(III) impurities, the exposure of the cathode to a moist atmosphere brings about a deterioration in the cycling capacity. Expressed in % of loss in capacity per 100 cycles, the loss in capacity of the 100 cycles is approximately 4.1% for A6, 1.5% for B6 and 1.6% for C6.

The following were prepared according to the process used for the preparation of the batteries A6, B6 and C6 respectively:
batteries A6.1, B6.1 and C6.1 by replacing the material C—LiFePO₄ of example 1a with the material C—LiFe_{0.5}Mn_{0.5}PO₄ of example 1b,
batteries A6.2, B6.2 and C6.2 by replacing the material C—LiFePO₄ of example 1a with the material C—LiFe_{0.98}Mg_{0.02}PO₄ of example 1c,
batteries A6.3, B6.3 and C6.3 by replacing the material C—LiFePO₄ of example 1a with the material C—LiFePO₄ of example 1d.

The loss in capacity after 100 cycles for each battery is shown in the following table:

| | | | | | |
|---|---|---|---|---|---|
| A6.1 | 4.0% | B6.1 | 1.4% | C6.1 | 1.5% |
| A6.2 | 3.9% | B6.2 | 1.6% | C6.2 | 1.5% |
| A6.3 | 5.2% | B6.3 | 1.3% | C6.3 | 1.4% |

### Jet Milling

The batteries A7 and B7 differ in that the material C—LiFePO₄ is used from its preparation in A7 and after milling for 3 min under compressed air with a dew point of −6° C.

FIG. 7 represents the cyclic voltammeter curves produced as above and FIG. 8 represents the galvanostatic curves, also produced as above.

The voltammeter curves show the formation of from 1.3 to 2% of Fe(III) phase and the galvanostatic cycling shows a significant increase in the loss in capacity at 60° C. after 100 cycles for the material milled at a dew point of −6° C. (6% instead of 2% for the unmilled material). On the other hand, milling carried out at a dew point of −70° C. does not significantly increase the loss in capacity.

Batteries A7.1 and B7.1 were prepared like A7 and B7 but replacing the material C—LiFePO₄ of example 1, a with the material C—LiFePO₄ of example 1d. The galvanostatic cycling shows a significant increase in the loss in capacity at 60° C. after 100 cycles for the material milled at a dew point of −6° C. (7.8% instead of 1.8% for the unmilled material).

### EXAMPLE 5

Batteries were assembled according to the procedure of example 3, use being made of compounds C—LiFePO₄ which have been subjected to various treatments before the preparation of the cathode. Each treatment was applied to two batteries. The influence of the treatment, with a duration of 10 hours, on the final specific capacity of the corresponding batteries is given in the following table.

| Treatment | Specific capacity | |
|---|---|---|
| LiFePO₄ directly resulting from example 1 | 91.7 | 92.2 |
| Storage in moist air in an autoclave at 100° C. | 85.8 | 85.6 |
| Washing with water under argon at 100° C. | 94.4 | 94.8 |
| Washing with water under air at 60° C. | 92.1 | 92.1 |
| Storage under dry air at 100° C. | 92.3 | 91.9 |
| Storage under moist argon in an autoclave at 100° C. | 90.8 | 90.5 |

The above results clearly show that water (contributed by an oxidizing gas atmosphere) causes deterioration to the material C-AMXO₄, which is reflected in general by the formation of Fe³⁺, in a form which is poorly defined but which is electrochemically active, and by the presence of related products, such as, for example, lithium hydroxide and phosphorus-comprising lithium compounds, which are optionally soluble. The Fe³⁺ compounds and said lithium compounds are capable of reacting with the components of an electrochemical cell in which the material C-AMXO₄ is used as electrode material and of affecting the functioning of said cell.

On the other hand, it has been found that, surprisingly, washing the material C-AMXO₄ with water makes it possible to retain its specific capacity analogous to that of a dry material C-AMXO₄, even when the washing is carried out under an oxidizing atmosphere.

1. A process for producing a cathode material having a water content of less than 1000 ppm throughout all stages of preparation, storage and use, comprising:
controlling an atmosphere around said material through a duration of the producing process so as to keep the water content in the material at a value of less than 1000 ppm at ambient temperature or throughout all the stages of preparation, said atmosphere either being an oxidizing atmosphere with a dew point of less than −30° C., or a nonoxidizing atmosphere,
wherein in the cathode material comprises C-AMXO₄, composed of particles of a compound corresponding to the formula AMXO₄ which have an olivine structure and which carry, on at least a portion of their surface, a carbon coating deposited by a thermal process, the formula AMXO₄ being such that:
A represents Li, alone or partially replaced by at most 10% as atoms of Na or K;
M represents Fe(II), alone or partially replaced by at most 50% as atoms of one or more other metals chosen from Mn, Ni and Co and/or by at most 10% as atoms of one or more aliovalent or isovalent metals other than Mn, Ni or Co, and/or by at most 5% as atoms of Pe(III); and
XO₄ represents PO₄, alone or partially replaced by at most 10 mol % of at least one group chosen from SO₄ and SiO₄.

2. The process as claimed in claim 1, wherein the material C-AMXO₄ is prepared by placing under thermodynamic or kinetic equilibrium, a gas atmosphere with a mixture in the required proportions of the following source compounds a), b), c), d) and e):
a) one or more compounds which are sources of the element or elements forming A;
b) a source or several sources of the element or elements forming M;
c) a compound which is a source of the element or elements X;
d) a compound which is a source of oxygen; and
e) a compound which is a source of conductive carbon;
the process comprising controlling the composition of said gas atmosphere, the temperature of the synthesis reaction and the level of the source compound c) relative to the other source compounds a), b), d) and e), in order to fix the oxidation state of the element M at the degree of valency desired for the structure of the compound of type AMXO₄, and at least one thermal step degradation of the compound e).

3. The process as claimed in claim 2, wherein the gas atmosphere is a stream of dry nitrogen moving countercurrent wise with respect to the source compounds.

4. The process as claimed in claim 2, for the preparation of a material C—LiFePO₄ comprising less than 1000 ppm of water, wherein:
the source compound a) is a lithium compound chosen from the group consisting of lithium oxide, lithium hydroxide, lithium carbonate, the neutral phosphate Li₃PO₄, the hydrogen phosphate LiH₂PO₄, lithium ortho-, meta- and polysilicates, lithium sulfate, lithium oxalate, lithium acetate and one of their mixtures;
the source compound b) is an iron compound chosen from the group consisting of iron (III) oxide, trivalent iron phosphate, lithium iron hydroxyphosphate, trivalent iron nitrate, ferrous phosphate, hydrated or nonhydrated vivianite Fe₃(PO₄), iron acetate (CH₃COO)₂Fe, iron sulfate (FeSO₄), iron oxalate, ammonium iron phosphate (NH₄FePO₄) and one of their mixtures; and
the source compound c) is a phosphorus compound chosen from the group consisting of phosphoric acid and its esters, the neutral phosphate Li₃PO₄, the hydrogen phosphate LiH₂PO₄, mono- and diammonium phosphates, trivalent iron phosphate and manganese ammonium phosphate (NH₄MnPO₄).

5. The process as claimed in claim 2, wherein the thermal step degradation of the compound e) is carried out at the same time as the synthesis reaction between the compounds a) to d) to form the compound AMXO₄ or in a stage in succession to the synthesis reaction.

6. The process as claimed in claim 1, wherein the source compound of conductive carbon is a compound which is in the liquid state or in the gas state, a compound which can be used in the form of a solution in a liquid solvent or a compound which changes to the liquid or gas state during its decomposition.

7. The process as claimed in claim 1, wherein the source compound of conductive carbon is chosen from the group consisting of liquid, solid or gaseous hydrocarbons and their derivatives, perylene and its derivatives, polyhydric compounds, polymers, cellulose, starch and their esters and ethers, and their mixtures.

8. The process as claimed in claim 1, wherein the source compound of conductive carbon is CO or a gaseous hydrocarbon and it is subjected to dismutation.

9. The process as claimed in claim 8, wherein the dismutation is catalyzed by a transition metal element present in at least one of the precursors a) to c) or by a compound of a transition metal added to the mixture of precursors.

10. The process as claimed in claim 1, wherein the source compound of conductive carbon is a gas chosen from the group consisting of ethylene, propylene, acetylene, butane, 1,3-butadiene, 1-butene and a mixture of at least two of them and the thermal decomposition is carried out by cracking in a furnace at a temperature between 100 and 1300° C. in the presence of an inert carrier gas.

11. The process as claimed in claim 1, wherein the source compound of conductive carbon is a hydrocarbon and the thermal step degradation is carried out by CVD.

12. The process as claimed in claim 1, further comprising a milling step carried out on a material C-AMXO₄, either under an oxidizing atmosphere with a dew point of less than −30° C., or under a nonoxidizng atmosphere.

13. The process as claimed in claim 12, wherein the milling is a jet milling.

14. The process as claimed in claim 1, further comprising washing the material C-AMXO₄ in water at a temperature of greater than 60° C., then recovering the material C-AMXO₄ by filtration and drying the material down to a maximum water content of 1000 ppm.

15. The process as claimed in claim 1, further comprising: placing said material immediately after the material has been obtained in a controlled atmosphere, said controlled atmosphere either being an oxidizing atmosphere with a dew point of less than −30° C., or a nonoxidizing atmosphere such that the material has a water content of less than 1000 ppm at ambient temperature or throughout all stages of preparation, storage and use.

16. An electrode, composed of a film of composite material deposited on a conductive substrate forming the current collector, wherein said composite material is composed of a material C-AMXO₄, a binder and a compound which conducts electrons, the C-AMXO₄, composed of particles of a compound corresponding to the formula AMXO₄ which have an olivine structure and which carry, on at least a portion of their surface, a carbon coating deposited by a thermal process, the formula AMXO₄ being such that:
A represents Li, alone or partially replaced by at most 10% as atoms of Na or K;
M represents Fe(II) , alone or partially replaced by at most 50% as atoms of one or more other metals chosen from Mn, Ni and Co and/or by at most 10% as atoms of one or more aliovalent or isovalent metals other than Mn, Ni or Co, and/or by at most 5% as atoms of Pe(III); and
XO₄ represents PO₄, alone or partially replaced by at most 10 mol % of at least one group chosen from SO₄ and SiO₄.

17. The electrode as claimed m claim 16, wherein the material C-AMXO₄ is C—LiFePO₄.

18. A battery, composed of an anode, a cathode and an electrolyte comprising a lithium salt, wherein the cathode comprises C-AMXO₄, composed of particles of a compound corresponding to the formula AMXO₄ which have an olivine structure and which carry, on at least a portion of their surface, a carbon coating deposited by a thermal process, the formula AMXO₄ being such that:
A represents Li, alone or partially replaced by at most 10% as atoms of Na or K;
M represents Fe(II), alone or partially replaced by at most 50% as atoms of one or more other metals chosen from Mn, Ni and Co and/or by at most 10% as atoms of one or more aliovalent or isovalent metals other than Mn, Ni or Co, and/or by at most 5% as atoms of Pe(III); and
XO₄ represents PO₄, alone or partially replaced by at most 10 mol % of at least one group chosen from SO₄ and SiO₄.

19. The battery as claimed m claim 18, wherein the material C-AMXO₄ is C—LiFePO₄.
